(19) United States
(12) Patent Application Publication
(10) Pub. No.: US 2026/0121159 A1
(43) Pub. Date: Apr. 30, 2026

(54) BATTERY PACK

(71) Applicant: HYUNDAI MOBIS CO., LTD., Seoul (KR)

(72) Inventor: Hwa Sung KIM, Yongin-si (KR)

(73) Assignee: HYUNDAI MOBIS CO., LTD., Seoul (KR)

(21) Appl. No.: 19/339,558

(22) Filed: Sep. 25, 2025

(30) Foreign Application Priority Data
Oct. 31, 2024 (KR) 10-2024-0152892

(51) Int. Cl. H01M 10/6556; H01M 10/613; H01M 10/617; H01M 10/63; H01M 50/204

(52) U.S. Cl. CPC H01M 10/6556; H01M 10/613; H01M 10/617; H01M 10/63; H01M 50/204

(57) ABSTRACT

A battery pack and a cooling apparatus therefor are provided. The battery pack includes a casing part to accommodate a battery group, the casing part includes a lower casing region and having a lower flow path, and an upper casing region having an upper flow path. When a cooling fluid is supplied to the flow path, a flow direction of the cooling fluid in a first upper flow path region of the upper flow path is opposite to a flow direction of the cooling fluid in a first lower flow path region of the lower flow path that faces the first upper flow path region in a vertical direction.

### CROSS-REFERENCE TO RELATED APPLICATION

This application claims priority to and the benefit under 35 USC § 119(a) of Korean Patent Application No. 10-2024-0152892 filed in the Korean Intellectual Property Office on Oct. 31, 2024, the entire contents of which are incorporated herein by reference for all purposes.

### BACKGROUND

### 1. Field

The present disclosure relates to a battery pack, and more particularly, to a battery pack including a structure capable of cooling a battery.

### 2. Description of the Related Art

The performance of a battery mounted in an electric vehicle acts as an important factor for determining the performance and lifespan of the electric vehicle. For example, because the battery generates a large amount of heat while being charged or discharged, the battery needs to be cooled. The battery mounted in the electric vehicle needs to be effectively cooled so that the battery operates smoothly.

Meanwhile, depending on whether a fluid for cooling the battery flows while facing one surface of the battery, methods of cooling the batteries may be classified into a single-sided cooling method, a double-sided cooling method, and the like. Among the methods, the single-sided cooling method refers to a cooling method in which the fluid for cooling the battery flows while facing one surface of the battery. However, in the related art, the single-sided cooling method has a problem in that the other surface of the battery, which is opposite to one surface of the battery, cannot properly exchange heat with the cooling fluid, which causes a large cooling deviation between regions of the battery.

Meanwhile, the double-sided cooling method in the related art refers to a cooling method in which the cooling fluid flows while facing two opposite surfaces (e.g., upper and lower surfaces) of the battery in order to solve the problem with the above-mentioned single-sided cooling method. In this case, the double-sided cooling method is advantageous in cooling the two opposite surfaces of the battery, but has a problem in that a degree to which the battery is cooled varies depending on the positions of the batteries. That is, a large cooling deviation occurs between the batteries because the battery, which exchanges heat with the cooling fluid that flows through a flow path in an upstream region of a cooling flow path, is relatively more cooled, whereas the battery, which exchanges heat with the cooling fluid that flows through a flow path in a downstream region of the cooling flow path, is relatively less cooled.

### SUMMARY

The present disclosure has been made in an effort to minimize a cooling deviation between batteries in a battery pack to which a double-sided cooling method is applied, thereby improving overall cooling performance of the battery pack.

In order to achieve the above-mentioned object, one aspect of the present disclosure provides a battery pack including: a battery group including a plurality of battery cells, the battery cells including electrodes and separators; a casing part including an accommodation space configured to accommodate the battery group, and a flow path spaced apart from the accommodation space and configured to allow a cooling fluid to flow therethrough; and first and second connection parts connected to one side of the casing part and configured to communicate with the flow path of the casing part, in which the casing part includes: a lower casing region provided below the battery group and having therein a lower flow path of the flow path; and an upper casing region provided above the battery group and having therein an upper flow path of the flow path, and in which when the cooling fluid is supplied to the flow path through the first connection part or the second connection part, a flow direction of the cooling fluid in a first upper flow path region of the upper flow path is opposite to a flow direction of the cooling fluid in a first lower flow path region of the lower flow path that faces the first upper flow path region in a vertical direction.

The casing part may further include a lateral connection region provided on horizontal lateral portions of the plurality of battery groups and configured to connect the lower casing region and the upper casing region, a lateral flow path of the flow path may be formed in the lateral connection region and communicate with the first connection part or the second connection part, and the lateral flow path may be divided into a section extending upward and a section extending downward in a portion where the first connection part and the lateral flow path meet together and a portion where the second connection part and the lateral flow path meet together.

The battery pack may further include: a jump flow path part coupled to one side of the upper casing region, wherein the jump flow path part may include a jump flow path having a first side configured to communicate with the lateral flow path, and a second side configured to communicate with the upper flow path, and in which the first side of the jump flow path and the second side of the jump flow path are spaced apart from each other in a horizontal direction.

A portion of the upper flow path, which is connected to the second side of the jump flow path, may define one end of the upper flow path.

The upper flow path may further include a spacing flow path region extending in a direction toward the second connection part from a first lateral flow path of the lateral flow path that communicates with the first connection part, and one end of the spacing flow path region may be positioned between the first lateral flow path configured to communicate with the first connection part and a second lateral flow path of the lateral flow path, which communicates with the second connection part, when viewed from above.

The first side of the jump flow path may communicate with the second lateral flow path, and the jump flow path part may be coupled to an upper side of the upper casing region.

The jump flow path may be formed above the upper flow path.

The second side of the jump flow path may be positioned inward of the first side of the jump flow path in the horizontal direction.

A length of a section extending upward from a portion where the lateral flow path meets the first connection part and the second connection part may be longer than a length of a section extending downward from a portion where the lateral flow path meets the first connection part and the second connection part.

The first upper flow path region and the first lower flow path region may have shapes corresponding to each other.

In another general aspect, a cooling apparatus for a battery group including a plurality of battery cells, includes: a casing including an accommodation space for housing the battery group, an upper casing facing a top side of the battery group and including an upper flow path region, a lower casing facing a bottom side of the battery group and including a lower flow path region, a first connection part connected to respective inlets of the upper flow path region and the lower flow path region, and a second connection part connected to respective outlets of the upper flow path region and the lower flow path region; a heat exchanger to remove heat; and a pump connected to the heat exchanger to pump cooling fluid into the first connection part such that the cooling fluid moves through the upper flow path region and the lower flow path region to remove heat from the top side and the bottom side of the battery group, wherein a flow direction of the cooling fluid in the upper flow path region is different from the flow direction of the cooling fluid in the lower flow path region.

The flow direction of the cooling fluid in the upper flow path region may be opposite to the flow direction of the cooling fluid in the lower flow path region.

The cooling apparatus may further include a controller configured to control the pump to circulate the cooling fluid in the upper flow path region and the lower flow path region.

The controller may be further configured to control the pump to reverse the flow of the cooling fluid, based on a change in temperature in at least one of the upper flow path region and the lower flow path region.

According to the present disclosure, it is possible to improve the overall cooling performance of the battery pack by minimizing a cooling deviation between the batteries in the battery pack to which the double-sided cooling method is applied.

### BRIEF DESCRIPTION OF THE DRAWINGS

FIG. 1 is an enlarged view illustrating a casing part, a first connection part, and a second connection part that constitute a battery pack according to the present disclosure.

FIG. 2 is a view illustrating a cross-sectional structure of the first connection part and cross-sectional structures of components around the first connection part in the battery pack according to the present disclosure.

FIG. 3 is a view illustrating a cross-sectional structure of the second connection part and cross-sectional structures of components around the second connection part in the battery pack according to the present disclosure.

FIG. 4 is a view schematically illustrating a lower casing region and a lower flow path of the battery pack according to the present disclosure.

FIG. 5 is a view schematically illustrating an upper casing region, an upper flow path, and a jump flow path part of the battery pack according to the present disclosure.

FIG. 6 is an enlarged view illustrating the jump flow path part in FIG. 5.

FIG. 7 is a view illustrating a flow path and a jump flow path defined by the battery pack according to the present disclosure.

### DETAILED DESCRIPTION

Hereinafter, a battery pack according to the present disclosure will be described with reference to the drawings.

### Battery Pack

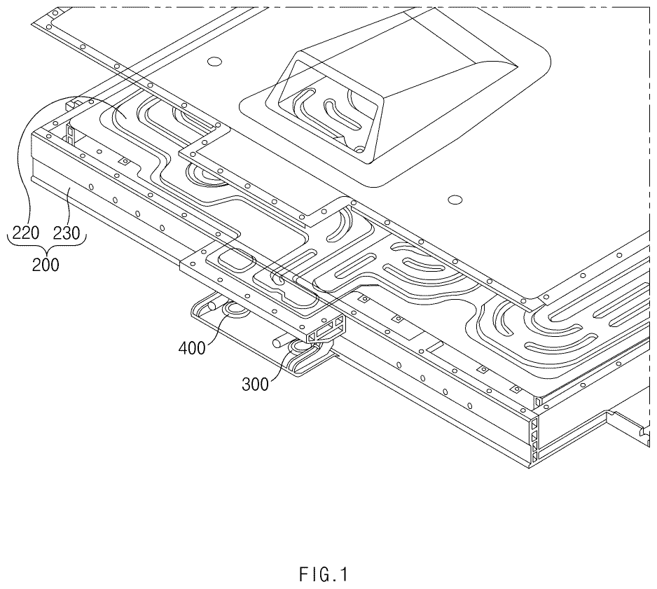

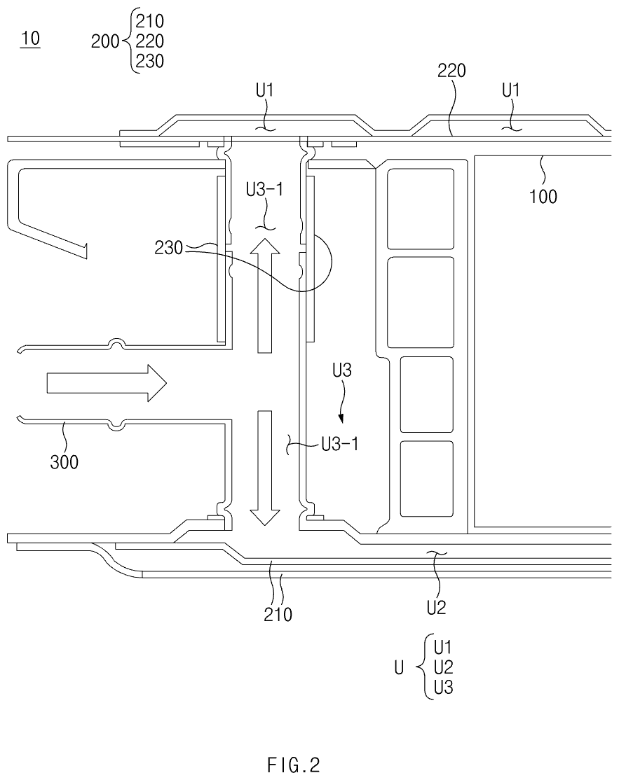

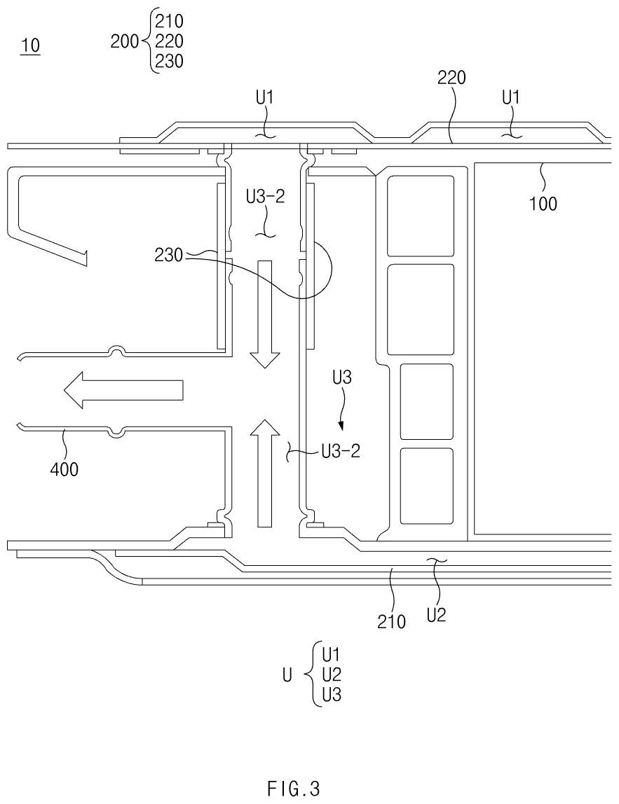

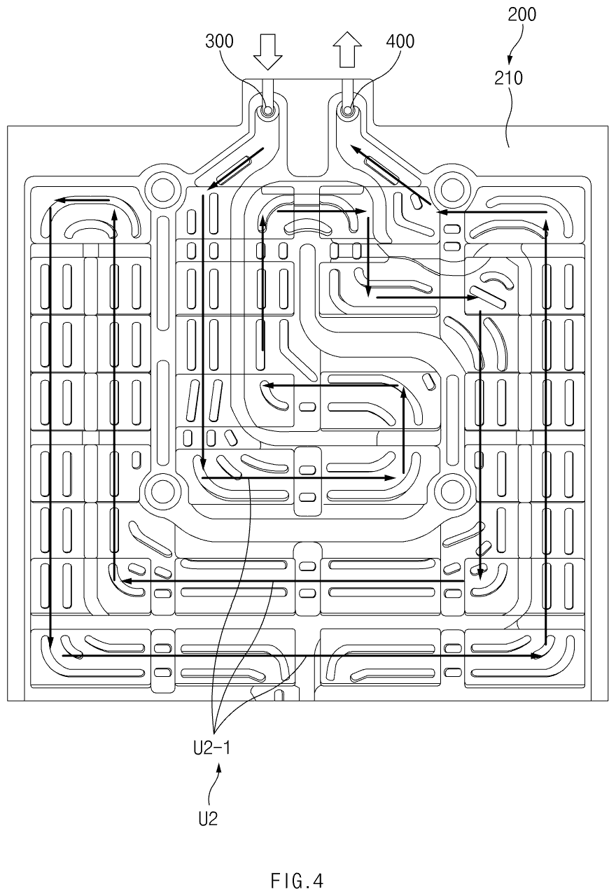

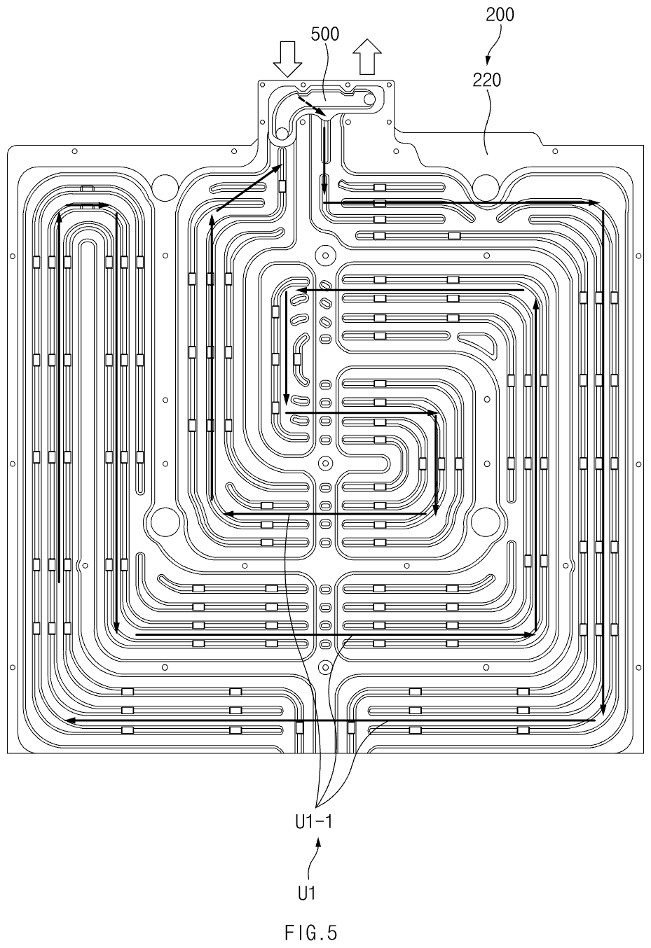

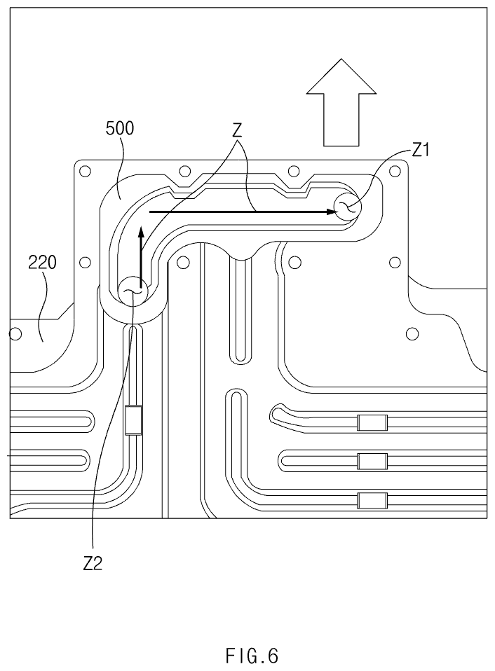

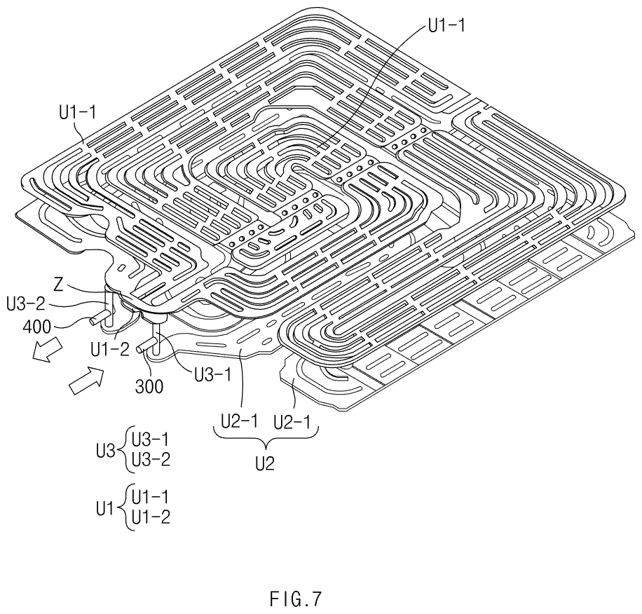

FIG. 1 is an enlarged view illustrating a casing part, a first connection part, and a second connection part that constitute a battery pack according to the present disclosure, and FIG. 2 is a view illustrating a cross-sectional structure of the first connection part and cross-sectional structures of components around the first connection part in the battery pack according to the present disclosure. FIG. 3 is a view illustrating a cross-sectional structure of the second connection part and cross-sectional structures of components around the second connection part in the battery pack according to the present disclosure, and FIG. 4 is a view schematically illustrating a lower casing region and a lower flow path of the battery pack according to the present disclosure. FIG. 5 is a view schematically illustrating an upper casing region, an upper flow path, and a jump flow path part of the battery pack according to the present disclosure, and FIG. 6 is an enlarged view illustrating the jump flow path part in FIG. 5. FIG. 7 is a view illustrating a flow path and a jump flow path defined by the battery pack according to the present disclosure.

With reference to FIGS. 1 to 3, a battery pack 10 according to the present disclosure may include a battery group 100 including a plurality of battery cells including electrodes and separators, a casing part 200 having an accommodation space configured to accommodate the battery group 100, and a flow path U spaced apart from the accommodation space and configured to allow a cooling fluid to flow therethrough, and first and second connection parts 300 and 400 connected to one side of the casing part 200 and configured to communicate with the flow path U of the casing part 200. For example, the first connection part 300 may be an inlet part configured to provide a route through which the cooling fluid is supplied to the flow path U of the casing part 200, and the second connection part 400 may be an outlet part configured to provide a route through which the cooling fluid is discharged from the flow path U of the casing part 200. However, unlike the above-mentioned configuration, the first connection part 300 may be an outlet part, and the second connection part 400 may be an inlet part.

Meanwhile, the casing part 200 may be divided into a plurality of regions. More specifically, the casing part 200 may include a lower casing region 210 provided below the battery group 100 and having therein a lower flow path U2 of the flow path U, an upper casing region 220 provided above the battery group 100 and having therein an upper flow path U1 of the flow path U, and a lateral connection region 230 provided on horizontal lateral portions of the plurality of battery groups 100 and configured to connect the lower casing region 210 and the upper casing region 220. In this case, a lateral flow path U3 of the flow path U may be formed in the lateral connection region 230 and communicate with the first connection part 300 or the second connection part 400 (more specifically, a space in the first connection part or a space in the second connection part). More particularly, the lateral flow path U3 may communicate with the first connection part 300 and the second connection part 400. That is, with reference to FIGS. 2 and 3, in a portion where the first connection part 300 and the lateral flow path U3 meet together and a portion where the second connection part 400 and the lateral flow path U3 meet together, the lateral flow path U3 may be divided into a section extending upward and a section extending downward. Therefore, the section of the lateral flow path U3, which extends upward from the first connection part 300 or the second connection part 400, may communicate with the upper flow path U1, and the section of the lateral flow path U3, which extends downward from the first connection part 300 or the second connection part 400, may communicate with the lower flow path U2.

Meanwhile, it is noted that the descriptions of the vertical direction and the horizontal direction of the battery pack in the present specification are concepts introduced for convenience in order to explain the components of the battery pack, and the directions do not limit the arrangement direction of the battery pack during actual use. That is, for example, the battery pack according to the present disclosure may be used in an orientation inverted from the vertical direction defined in the present specification. The battery pack according to the present disclosure may be used in a state in which the horizontal direction defined in the present specification is replaced with the vertical direction.

Meanwhile, the lower casing region 210, the upper casing region 220, and the lateral connection region 230 may be formed integrally with one another or formed as separate regions. For example, the lower casing region 210 and the lateral connection region 230 may be coupled to each other or formed integrally with each other, and the upper casing region 220 may serve as a cover member coupled to an upper side of the lateral connection region 230. However, the lateral connection region 230 may be configured to be separately from the upper casing region 220 and the lower casing region 210. For example, the lateral connection region 230 may define a part of a hose member or connector member having therein the lateral flow path U3.

Meanwhile, the upper flow path U1 may include a first upper flow path region U1-1, and the lower flow path U2 may include a first lower flow path region U2-1 provided to face the first upper flow path region U1-1 in the vertical direction. In this case, according to the present disclosure, when the cooling fluid is supplied to the flow path U through the first connection part 300 or the second connection part 400, a flow direction of the cooling fluid in the first upper flow path region U1-1 of the upper flow path U1 may be opposite to a flow direction of the cooling fluid in the first lower flow path region U2-1 of the lower flow path U2 provided to face the first upper flow path region U1-1 in the vertical direction.

According to the present disclosure, the battery group 100 provided in the battery pack 10 may be cooled by the cooling fluid, which flows along the upper flow path U1 formed above the battery group 100, and the cooling fluid that flows along the lower flow path U2 formed below the battery group 100. That is, according to the present disclosure, two opposite sides of the battery group 100 based on the vertical direction may be cooled by the cooling fluid.

In this case, according to the present disclosure, a flow direction of the cooling fluid flowing along the upper flow path (more specifically, the first upper flow path region U1-1) facing an upper side of at least one portion of the battery group 100 may be opposite to a flow direction of the cooling fluid flowing along the lower flow path (more specifically, the first lower flow path region U2-1) facing a lower side of one portion of the battery group 100. In this case, a cooling deviation between the plurality of battery cells in the battery group 100 may be minimized. More particularly, with reference to FIGS. 1 to 5, the first upper flow path region U1-1 may be formed over the entire region of the upper flow path U1 that faces the battery group 100 in the vertical direction, and the first lower flow path region U2-1 may be formed over the entire region of the lower flow path region U2 that faces the battery group 100 in the vertical direction. Meanwhile, the first upper flow path region U1-1 and the first lower flow path region U2-1 may have shapes facing each other in the vertical direction and corresponding to each other. This configuration may be provided to uniformly cool the battery group 100 by means of the cooling fluid.

In order to achieve the above-mentioned function, according to the present disclosure, the battery pack 10 according to the present disclosure may further include a jump flow path part 500 coupled to one side of the upper casing region 220. The jump flow path part 500 may be configured such that a portion where the cooling fluid is supplied to the upper flow path U1 through the lateral flow path U3 is spaced apart, in the horizontal direction, from a portion where the cooling fluid is supplied to the lower flow path U2 through the lateral flow path U3, such that the flow direction of the cooling fluid flowing along the upper flow path U1 and the flow direction of the cooling fluid flowing along the lower flow path U2 are generally opposite to each other.

More specifically, the jump flow path part 500 may have therein a jump flow path Z having a first side Z1 configured to communicate with the lateral flow path U3, and a second side Z2 configured to communicate with the upper flow path U1. In this case, the first side Z1 of the jump flow path Z and the second side Z2 of the jump flow path Z may be spaced apart from each other in the horizontal direction. More particularly, a portion of the upper flow path U1, which is connected to the second side Z2 of the jump flow path Z, may define one end of the upper flow path U1.

Meanwhile, with reference to FIGS. 1, 2, and 3, the first connection part 300, the second connection part 400, and the lateral connection region 230 may each be a hose member or connector member having therein a flow path. More specifically, the first connection part 300, the second connection part 400, and the lateral connection region 230 may each define a part of a hose member or connector member. It may be understood that the first connection part 300 and the lateral connection region 230 are integrated, and the second connection part 300 and the lateral connection region 230 are integrated.

Hereinafter, detailed shapes of the flow path U and the jump flow path Z formed in the battery pack according to the present disclosure will be described.

With reference to FIG. 7, the upper flow path U1 may further include a spacing flow path region U1-2 extending in the horizontal direction toward the second connection part 400 from a first lateral flow path U3-1 of the lateral flow path U3 that communicates with the first connection part 300. More specifically, one end of the spacing flow path region U1-2 may communicate with the first lateral flow path U3-1, and the other end of the spacing flow path region U1-2 may communicate with the first upper flow path region U1-1.

In this case, as illustrated in FIG. 7, when viewed from above, the other end of the spacing flow path region U1-2 may be positioned between i) the first lateral flow path U3-1 configured to communicate with the first connection part 300 and ii) a second lateral flow path U3-2 of the lateral flow path U3 that communicates with the second connection part 400. In addition, the first side Z1 of the jump flow path Z may communicate with the second lateral flow path U3-2, and the jump flow path part 500 may be coupled to an upper side of the upper casing region 220. More particularly, as illustrated in FIGS. 5 and 6, the jump flow path Z may be formed above the upper flow path U1. For example, as illustrated in FIGS. 5 and 6, the second side Z2 of the jump flow path Z may be positioned inward of (inward, in a forward/rearward direction based on FIGS. 5 and 6, of) the first side Z1 of the jump flow path Z in the horizontal direction.

Meanwhile, for example, as illustrated in FIGS. 2 and 3, a length of a section extending upward from a portion where the lateral flow path U3 meets the first connection part 300 and the second connection part 400 may be longer than a length of a section extending downward from a portion where the lateral flow path U3 meets the first connection part 300 and the second connection part 400.

A process in which the cooling fluid flows in the battery pack 10 according to the present disclosure will be described below with reference to the above-mentioned description.

The cooling fluid is supplied to the first lateral flow path U3-1 through the first connection part 300 in case that the first connection part 300 is an inlet part and the second connection part 400 is an outlet part. In this case, the cooling fluid flowing in the section of the first lateral flow path U3-1 extending upward from the first connection part 300 is introduced into the upper flow path U1, and the cooling fluid flowing in the section of the first lateral flow path U3-1 extending downward from the first connection part 300 is introduced into the lower flow path U2.

In this case, the cooling fluid introduced into the upper flow path U1 is introduced into the first upper flow path region U1-1 via the spacing flow path region U1-2 and exchanges heat with the upper side of the battery group 100, and the cooling fluid introduced into the lower flow path U2 is introduced into the first lower flow path region U2-1 and exchanges heat with the lower side of the battery group 100. Thereafter, the cooling fluid, which has flowed through the first upper flow path region U1-1 or the first lower flow path region U2-1, sequentially passes through the second lateral flow path U3-2 and the second connection part 400 and then is discharged to the outside of the battery pack.

According to the present disclosure, a portion of the battery group 100, which is cooled by the cooling fluid flowing in an upstream section of the upper flow path U1, may be cooled by the cooling fluid flowing in a downstream section of the lower flow path U2. In contrast, a portion of the battery group 100, which is cooled by the cooling fluid flowing in an upstream section of the lower flow path U2, may be cooled by the cooling fluid flowing in a downstream section of the upper flow path U1. Therefore, according to the present disclosure, a degree to which the battery group is cooled by the cooling fluid, may be uniformly maintained regardless of the positions of the battery cells in the battery group 100.

Further, a controller (e.g., a processor) may control a pump to circulate the coolant fluid through a heat exchanger. The controller may further control the pump to reverse the flow of the cooling fluid, based on a change in temperature in at least one of the upper flow path region and the lower flow path region.

The present disclosure has been described with reference to the limited embodiments and the drawings, but the present disclosure is not limited thereby. The present disclosure may be carried out in various forms by those skilled in the art, to which the present disclosure pertains, within the technical spirit of the present disclosure and the scope equivalent to the appended claims.

What is claimed is:

1. A battery pack comprising:
a battery group comprising a plurality of battery cells, the battery cells comprising electrodes and separators;
a casing part including:
an accommodation space configured to accommodate the battery group; and
a flow path spaced apart from the accommodation space and configured to allow a cooling fluid to flow therethrough; and
first and second connection parts connected to one side of the casing part and configured to communicate with the flow path of the casing part,
wherein the casing part comprises:
a lower casing region provided below the battery group and having therein a lower flow path of the flow path; and
an upper casing region provided above the battery group and having therein an upper flow path of the flow path, and
wherein when the cooling fluid is supplied to the flow path through the first connection part or the second connection part, a flow direction of the cooling fluid in a first upper flow path region of the upper flow path is opposite to a flow direction of the cooling fluid in a first lower flow path region of the lower flow path that faces the first upper flow path region in a vertical direction.

2. The battery pack of claim 1, wherein the casing part further comprises a lateral connection region provided on horizontal lateral portions of the plurality of battery groups and configured to connect the lower casing region and the upper casing region,
wherein a lateral flow path of the flow path is formed in the lateral connection region and communicates with the first connection part or the second connection part, and
wherein the lateral flow path is divided into a section extending upward and a section extending downward in a portion where the first connection part and the lateral flow path meet together and a portion where the second connection part and the lateral flow path meet together.

3. The battery pack of claim 2, further comprising:
a jump flow path part coupled to one side of the upper casing region,
wherein the jump flow path part includes:
a jump flow path having a first side configured to communicate with the lateral flow path; and
a second side configured to communicate with the upper flow path, and
wherein the first side of the jump flow path and the second side of the jump flow path are spaced apart from each other in a horizontal direction.

4. The battery pack of claim 3, wherein a portion of the upper flow path, which is connected to the second side of the jump flow path, defines one end of the upper flow path.

5. The battery pack of claim 3, wherein the upper flow path further comprises a spacing flow path region extending in a direction toward the second connection part from a first lateral flow path of the lateral flow path that communicates with the first connection part, and
wherein one end of the spacing flow path region is positioned between the first lateral flow path configured to communicate with the first connection part and a second lateral flow path of the lateral flow path, which communicates with the second connection part, when viewed from above.

6. The battery pack of claim 3, wherein the first side of the jump flow path communicates with the second lateral flow path, and the jump flow path part is coupled to an upper side of the upper casing region.

7. The battery pack of claim 6, wherein the jump flow path is formed above the upper flow path.

8. The battery pack of claim 3, wherein the second side of the jump flow path is positioned inward of the first side of the jump flow path in the horizontal direction.

9. The battery pack of claim 2, wherein a length of a section extending upward from a portion where the lateral flow path meets the first connection part and the second connection part is longer than a length of a section extending downward from a portion where the lateral flow path meets the first connection part and the second connection part.

10. The battery pack of claim 1, wherein the first upper flow path region and the first lower flow path region have shapes corresponding to each other.

11. A cooling apparatus for a battery group including a plurality of battery cells, the cooling apparatus comprising:
a casing including:
an accommodation space for housing the battery group;
an upper casing facing a top side of the battery group and including an upper flow path region;
a lower casing facing a bottom side of the battery group and including a lower flow path region;
a first connection part connected to respective inlets of the upper flow path region and the lower flow path region; and
a second connection part connected to respective outlets of the upper flow path region and the lower flow path region;
a heat exchanger configured to remove heat; and
a pump connected to the heat exchanger and configured to pump cooling fluid into the first connection part such that the cooling fluid moves through the upper flow path region and the lower flow path region to remove heat from the top side and the bottom side of the battery group,
wherein a flow direction of the cooling fluid in the upper flow path region is different from the flow direction of the cooling fluid in the lower flow path region.

12. The cooling apparatus of claim 11, wherein the flow direction of the cooling fluid in the upper flow path region is opposite to the flow direction of the cooling fluid in the lower flow path region.

13. The cooling apparatus of claim 11, further comprising:
a controller configured to control the pump to circulate the cooling fluid in the upper flow path region and the lower flow path region.

14. The cooling apparatus of claim 13, wherein the controller is further configured to control the pump to reverse the flow of the cooling fluid, based on a change in temperature in at least one of the upper flow path region and the lower flow path region.
